(19) United States
(12) Patent Application Publication
(10) Pub. No.: US 2003/0150106 A1
(43) Pub. Date: Aug. 14, 2003

(54) Insulation displacement connection apparatus for wires

(76) Inventors: Yuji Ikeda, Kanagawa (JP); Shunichi Shoji, Tokyo (JP)

Correspondence Address: John S. Beulick, Armstrong Teasdale LLP, Suite 2600, One Metropolitan Sq., St. Louis, MO, 63102, US

(21) Appl. No.: 10/366,785

(22) Filed: Feb. 14, 2003

(30) Foreign Application Priority Data
Feb. 14, 2002 (JP) 2002-36296

(51) Int. Cl. B23P 19/00; H01R 43/04

(52) U.S. Cl. 29/761; 29/751; 29/861

(57) ABSTRACT

A press die assembly is provided for joining wires with connectors that hold insulation displacement contacts and for crimping the connector about the wire. The housing holds contacts that have insulation displacement portions and crimping portions constructed of a pair of barrels. A press die assembly arranged above the contacts has stuffers for pressing wires onto the insulation displacement portions, crimpers for crimping the barrels about the wires, and guide members placed between the stuffers and the crimpers. The guide members slide along partition walls of a housing ahead of the crimpers to ensure proper alignment. The crimpers are constructed of a single member having a depth that sufficiently covers both ends of the pair of barrels of the crimping portion along the axial direction of the contact.

### CROSS REFERENCE TO RELATED APPLICATIONS

This application claims the benefit of Japanese Patent Application No. 2002-36296 filed Feb. 14, 2002, the complete subject matter of which is expressly incorporated by reference.

### BACKGROUND OF THE INVENTION

This invention relates generally to an insulation displacement connection apparatus for electrical wires, and, more particularly, to an insulation displacement connection apparatus including a stuffer for joining wires to electrical contacts and a crimper for crimping outer covering crimping barrels of the electrical contacts to the wires.

Insulation displacement connection apparatuses for electrical wires that establish electrical connections between the conductors of wires and the insulation displacement portions of electrical contacts are known. Typically, wires are press fit into slots of the insulation displacement portions of electrical contacts, and the edges of the slots tear the insulative outer coverings of the wires and establish electrical connections with the underlying conductors. Also, outer covering crimping barrels are typically provided in the electrical connectors so as to prevent faulty electrical connections due to tensile forces acting on the wires at the insulation displacement portions. The outer covering crimping barrels are crimped on the outer insulative coverings of the wires at positions separated from the insulation displacement portions. Crimpers provided in the insulation displacement connection apparatus are used to crimp the outer covering crimping barrels onto the wires. Guide members for guiding partition walls of housings for electrical connectors are utilized to guide the partition walls to a predetermined width so that they do not interfere with the crimper during the crimping operation.

For example, Japanese Unexamined Utility Model Publication No. 6 (1994)-19293 discloses electrical contacts placed within a contact housing cavity defined by a plurality of partition walls of an insulative housing. A crimper crimps outer covering barrels of the electrical contacts onto the insulative covering of the wires. The crimper is constructed of two blade dies that overlap each other. Each blade die includes a crimping portion for crimping the outer covering crimping barrels and a wall guide portion for guiding the partition walls corresponding to each electrical contact. The wall guide portions are provided to maintain the partition walls at predetermined positions so that the crimper does not contact the partition walls as the crimper descends toward the electrical contacts during the crimping operation. The positions of the crimping portions and the wall guide portions are reversed between the two blade dies, and the two blade dies act in cooperation as a single unit to perform the guiding of the walls of the electrical contacts and the crimping of the outer covering crimping barrels.

This construction is disadvantaged in several aspects. For instance, the crimper is constructed of two blade dies, which increases the number of parts in the assembly. Additionally, each blade die is formed corresponding to each pair of outer covering crimping barrels, of which the positions of the distal ends thereof are not aligned in the axial direction (the longitudinal direction) of the electrical contacts. Therefore, the thickness of the blade dies along the axial direction cannot be made thick, and the strength thereof is reduced.

Japanese Unexamined Patent Publication No. 2000-340332 discloses an insulation displacement connection apparatus wherein distal end portions of upwardly facing outer covering crimping barrels are inclined slightly toward the interior. Inclination of the crimping barrels enables crimping of the outer covering crimping barrels by the crimper without interfering with partition walls, and wall guide members are not provided.

In such a construction it is necessary that the width of the crimper be set to be smaller than the interval between the partition walls of the insulative housing. This is so that the crimper does not interfere with the partition walls during insulation displacement. Consequently, when the center of the crimper and the center of the electrical contacts are not aligned due to dimensional tolerances of the insulative housing or the outer covering crimping barrels, there is a risk that one side of the outer covering crimping barrels is not crimped on the outer covering of the wires. In an extreme case, there is a risk that the crimper interferes with the partition walls.

### BRIEF DESCRIPTION OF THE INVENTION

In accordance with an exemplary embodiment of the present invention, an insulation displacement connection apparatus for wires is provided that eliminates faulty crimping, has few parts, and affords sufficient strength in the crimper thereof.

In one aspect, and in accordance with an exemplary embodiment of the present invention, an insulation displacement connection apparatus is provided for a connector including an insulated housing having guiding side walls that define a contact housing space for housing an electrical contact. The electrical contact includes a pair of outer covering crimping barrels positionally shifted in the axial direction of the electrical contact. The assembly comprises a press die assembly comprising a stuffer for press contacting a wire to an insulation displacement portion of the electrical contact, a crimper for crimping outer covering crimping barrels of the electrical contact to the wire, and a guide member. The guide member is formed as a separate body from the crimper, and the guide member is positioned between the crimper and the stuffer.

In another aspect, and in accordance with an exemplary embodiment of the present invention, an insulation displacement connection apparatus for a connector is provided. The connector includes an insulated housing having partition walls that define a plurality of contact housing spaces for housing a plurality of electrical contacts. Each electrical contact includes an insulation displacement portion and a pair of outer covering crimping barrels positionally shifted in the axial direction of the electrical contact. The assembly comprises a press die assembly comprising a plurality of press blade dies, and each of the press blade dies corresponds to one of the contact housing spaces of the connector. Each press blade die includes a stuffer adapted to press contact a wire to the insulation displacement portion of one of the electrical contacts. A guide member extends from the stuffer and is adapted to prevent interference of the press die with the partition walls of one of the contact housing spaces. A crimper extends from the guide member opposite the stuffer and is constructed of a single member having a thickness that encompasses both ends of the crimping barrels. The crimper is thereby adapted to simultaneously crimp both outer covering crimping barrels of the electrical contact to the wire.

In yet another aspect, and in accordance with an exemplary embodiment of the invention, an insulation displacement connection apparatus for a plurality of wires is provided. The apparatus comprises a connector and a press die assembly. The connector comprises an insulated housing having partition walls that define a plurality of contact housing spaces for housing a plurality of electrical contacts. Each electrical contact includes a pair of outer covering crimping barrels positionally shifted in the axial direction of the electrical contacts. The press die assembly includes at least one press blade die arranged above the connector and descending thereupon to connect a wire to one of the contacts. The blade die comprises a stuffer adapted to press contact the wire to an insulation displacement portion of the contacts. A guide member extends from the stuffer and contacts the partition walls of one of the contact housing spaces corresponding to the contact. A crimper extends from the guide member opposite the stuffer and is constructed of a single member having a thickness that encompasses both ends of the crimping barrels. The crimper thereby simultaneously crimps both outer covering crimping barrels of the contact to the wire as the press die assembly descends upon the connector. The guide member enters one of the contact housing spaces prior to the crimper.

### BRIEF DESCRIPTION OF THE DRAWINGS

FIG. 1 is a perspective view of an exemplary electrical connector having insulation displacement type electrical contacts arranged in an insulative housing.

FIG. 2 is a schematic side view that of the connector shown in FIG. 1 illustrating the contacts arranged within the housing and an exemplary press die assembly in a partially sectional manner.

FIG. 3 is a partial sectional view of the connector and press die assembly illustrating the positional relationship of the press die assembly, the wires and the contacts prior to press contacting the wires to the contacts, taken from the rear of the contacts.

FIG. 4 is a partial sectional view of the connector and press die assembly illustrating the initial stage of the insulation displacement process, wherein the press die assembly has descended and engagement between the wires and the contacts has begun.

FIG. 5 is a partial sectional view of the connector and press die assembly illustrating a state wherein the press die assembly has descended further, and the crimpers and the barrels have come into contact.

FIG. 6 is a partial sectional view of the connector and press die assembly that shows a state wherein the crimpers have completely crimped the barrels.

FIG. 7 is a schematic side view of the connector and press die assembly in a state wherein insulation displacement connection of the wires is complete.

### DETAILED DESCRIPTION OF THE INVENTION

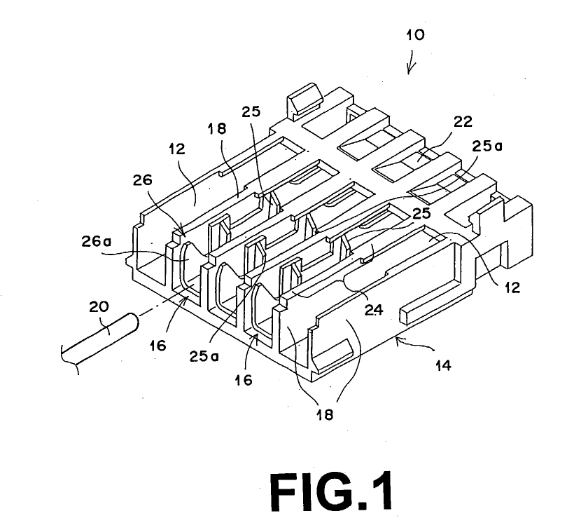

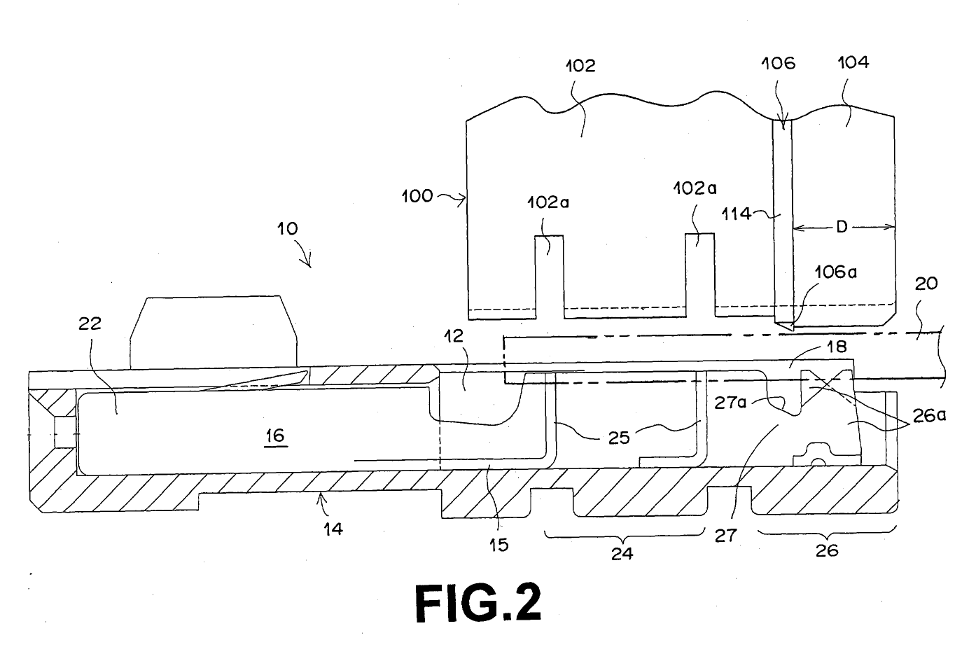

FIG. 1 illustrates an exemplary connector 10 including an insulative housing 14 having a plurality of contact housing spaces 12 formed therein. Contacts 16 are placed within the contact housing spaces 12. The contacts 16 are placed between partition walls 18 that define the contact housing spaces 12. Each contact housing space 12 has an open top and is structured to allow a press die assembly 100 (shown in FIG. 2 and describe below) to enter the contact housing space 12 from above to establish insulation displacement connections of wires 20 onto the contacts 16 and to perform crimping. The manner in which the wires 20 are connected to the contacts 16 is described in some detail below. While the invention is described and illustrated with respect to a particular connector 10, it is understood that the benefits of the present invention may accrue to other types of connectors, and connector 10 is therefore set forth by way of illustration rather than limitation.

The contacts 16 shown in FIG. 1 are of a conventional type. Each contact 16 is provided with a contact portion 22 on the front portion of the engagement portion of the connector 10. Each contact 16 also includes an insulation displacement portion 24 and a crimping portion 26. The insulation displacement portion 24 and the crimping portion 26 are provided in the listed order from the contact portion 22 toward the rear. The insulation displacement portion 24 includes two insulation displacement plates 25 which are separated in the axial direction of the contact 16, and wire insulation displacement slots 25a formed by the insulation displacement plates 25. The slots 25a are formed extending in the vertical direction, that is, the wire insulation displacing direction, and are open in the upward direction. The crimping portion 26 includes a pair of outer covering crimping barrels 26a which are protrusively provided in the width direction of the contact 16. The purpose of the slots 25a and the barrels 26a is to electrically connect the wires 20, and to provide strain relief thereto, as described previously.

FIG. 2 illustrates a contact 16 arranged within the housing 14 with an exemplary press die assembly 100 located in a state before wire insulation displacement is performed. For clarity, only the main portions of the contact 16 are shown in FIG. 2. It is clearly shown that the two insulation displacement plates 25 of the insulation displacement portion 24 are formed separated from each other in the axial direction of the contact 16. The insulation displacement plates 25 are formed by cutting and bending a bottom wall 15 of the contact 16. A pair of barrels 26a is capable of receiving the wire 20 therebetween and is protrusively provided to the rear of the insulation displacement plates 25.

Each barrel 26a has a tapered upwardly facing distal end portion. The barrels 26a are positionally shifted from each other along the axial direction of the contact 16, that is, the longitudinal direction thereof. In other words, the distal ends of barrels 26a are separated from one another by a predetermined distance along an axial direction of the contact 16. Separation of the barrel ends prevents interference of the barrels 26a with each other when they are crimped onto the wire 20, that is, when they become wound atop the wire 20. As illustrated in FIG. 2, the tip of the wire 20 that extends from the rear of the contact 16 is positioned to the front of the two insulation displacement plates 25.

The press die assembly 100 extends from the position of the insulation displacement portion 24 of contact 16 to that of the crimping portion 26 of the contact 16. The press die assembly 100 is arranged above the contact 16 so as to be capable of pressing the wire 20 toward the contact 16. The press die assembly 100 is formed of metal, and includes a stuffer 102, a crimper 104, and a guide member 106. The stuffer 102 serves to press contact the wire 20 at the insulation displacement portion 24 of contact 16. The crimper 104 serves to crimp the barrels 26a onto the wire 20. The guide member 106 serves to guide the partition walls 18 of the housing 14 and is arranged between the stuffer 102 and the crimper 104.

Stuffer 102 includes two recesses 102a for receiving the insulation displacement plates 25 during insulation displacement. The recesses 102a act as escapes for the insulation displacement plates 25 during insulation displacement. An arcuate surface (not shown) is formed along the axial direction of the wire 20 at the distal end (bottom) of the stuffer 102. In addition, the guide member 106 is arranged at a position corresponding to a transition portion 27 between the insulation displacement portion 24 and the crimping portion 26 of the contact 16. The guide member 106 is fixed to the stuffer 102 and the crimper 104.

In an exemplary embodiment, guide member 106 includes guide surfaces 106a formed at the distal end portion thereof, and lateral edges 114 for guiding the housing 14. The distal end portion of the guide member 106 enters a recess 27a of the transition portion 27 of contact 16 during insulation displacement. The crimper 104 is constructed of a single member having a depth D that sufficiently covers both ends of the pair of barrels 26a of the crimping portion 26 along the axial direction of the contact 16.

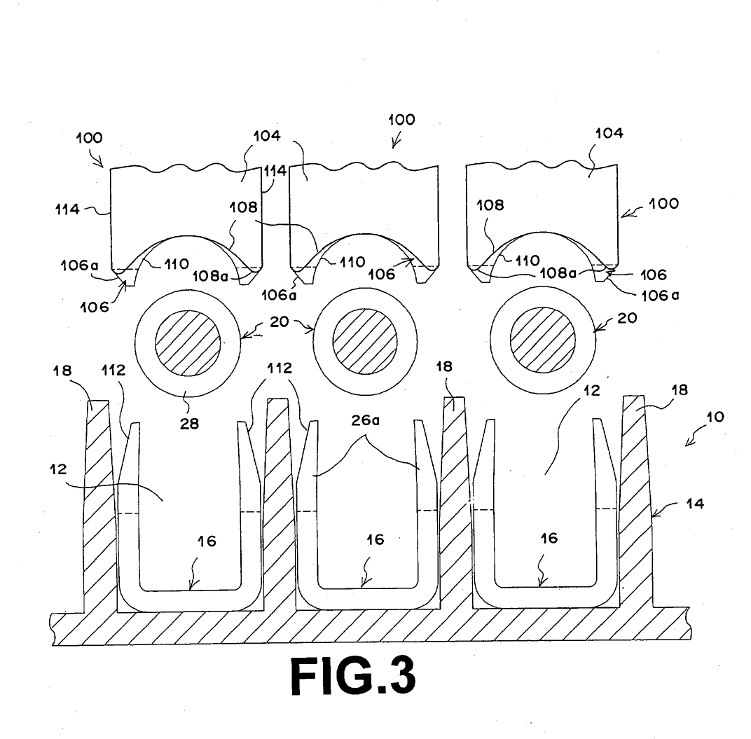

FIGS. 3-6 illustrate the operation of press contacting and crimping the wire 20 onto the contact 16 by driving the press die assembly 100 downward by an actuator (not shown) such as an air cylinder. It is recognized that other drive mechanisms familiar to those in the art may be employed to actuate press die assembly 100.

Referring to FIG. 3, the wires 20 are positioned between the press die assembly 100 and the contacts 16. The crimpers 104 have concavely arcuate crimping surfaces 108 at the bottom surfaces thereof. The crimping surfaces 108 have a greater radius of curvature than insulative outer coverings 28 of the wires 20. The edge portions of the crimping surfaces 108 are formed into small protrusive arcuate surfaces 108a. The guide members 106 are of substantially the same width as the crimpers 104, and have inwardly inclining guide surfaces 106a at the exterior sides of the distal end portions (bottom portions) thereof. The arcuate surfaces 108a are constructed so as to not protrude toward the exterior beyond the guide surfaces 106a.

A central portion of each of the guide members 106 are formed as concave regulating surfaces 110 which are complementary in shape to the insulative outer coverings 28 of the wires 20. The wires 20 are properly positioned in the direction perpendicular to the axial direction of the contacts 16, in the vicinity of the crimpers 104, by the regulating surfaces 110. Inward facing tapers 112 are formed on the exterior sides of the distal end portions (upper end portions) of the barrels 26a.

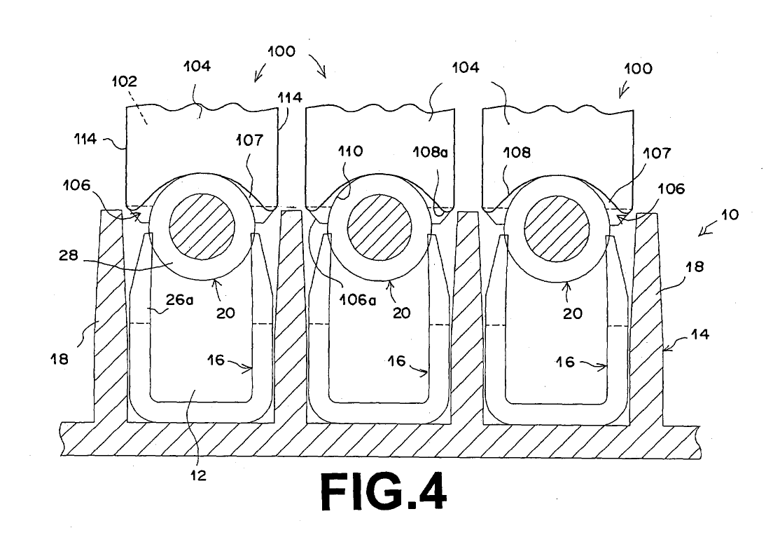

Referring now to FIG. 4, the press die assembly 100 is illustrated in a descended position. At this point, the regulating surfaces 110 of the guide members 106 position the wires 20 in a predetermined position in the direction perpendicular to the axial direction of the contacts 16. At the same time, the stuffers 102 and the guide members 106 press the wires 20 downward toward the contacts 16 to initiate insulation displacement. At this time, the crimpers 104 also press the wires 20 downward. In case that the press die assembly 100 and the housing 14 are positionally misaligned in the horizontal direction due to a dimensional tolerance of the housing 14 or the like, the guide surfaces 106a of the guide members 106 spread the partition walls 18 of the housing 14 to prevent interference between the partitions walls 18 and the press die assembly 100. As described previously, the crimping surfaces 108 have a greater radius of curvature than the insulative outer coverings 28 of the wires 20. Therefore, gaps 107 exist between the edges of the crimping surfaces 108 and the wires 20. This structure enables the barrels 26a to be held within the gaps 107 when the press die assembly 100 descends.

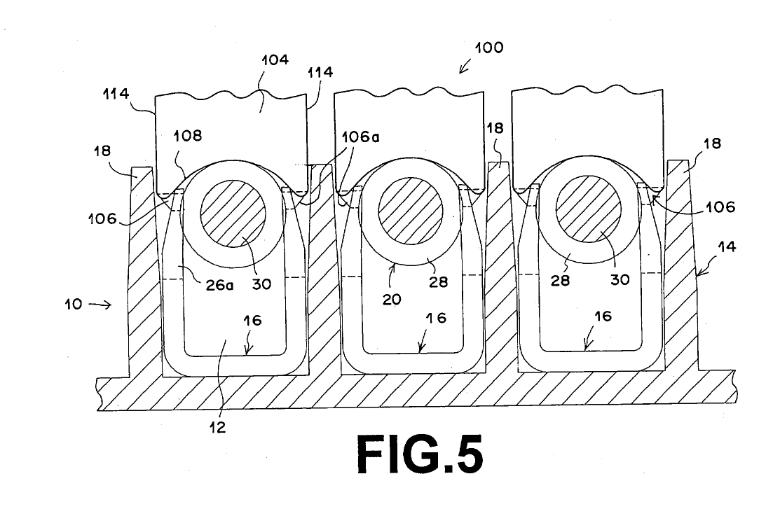

Referring now to FIG. 5, the press die assembly 100 is illustrated in a further descended position. At this point, the lateral edges 114 of the guide members 106 guide the partition walls 18, ahead of the crimpers 104 to prevent interference of the partition walls 18 with the crimpers 104. Unobstructed entrance paths for the crimpers 104 are therefore secured by guide members 106. The crimpers 104 descend, along with the guide members 106, into the spaces secured by the guide members 106, to deform the tips of the barrels 26a toward the interior of the contact housing spaces 12 along the crimping surfaces 108. Meanwhile, the wires 20 on the side of the insulation displacement portions 24 of the contact 16 are pressed into the slots 25a (shown in FIG. 1). The edges of the slots 25a tear the insulative outer coverings 28 of wires 20, contact the conducting cores 30 of the respective wires 20, and electrical connections are established therebetween.

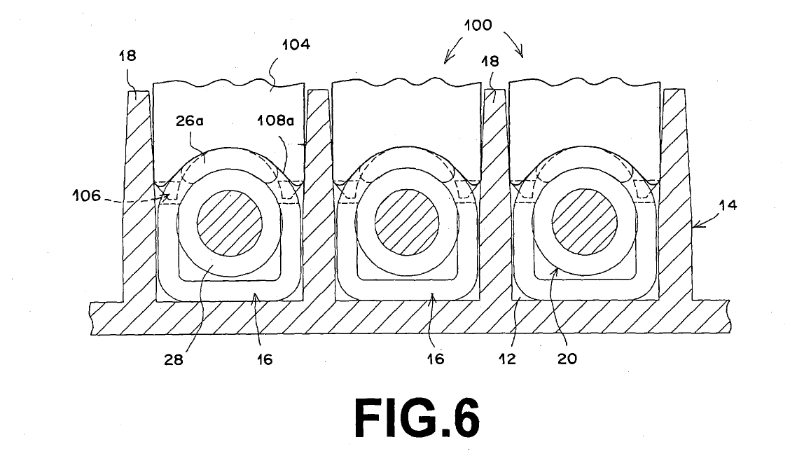

Referring now to FIG. 6, the pairs of barrels 26a are crimped onto the insulative outer coverings 28 of the wires 20 by being bent into an arcuate shape from both sides along the crimping surfaces 108 of the crimpers 104. That is, the wires 20 are fixed by the crimping portions 26 so that they will not move even if they are pulled or bent. The crimping portions 26 of contacts 16 therefore provide stress relief against prying forces.

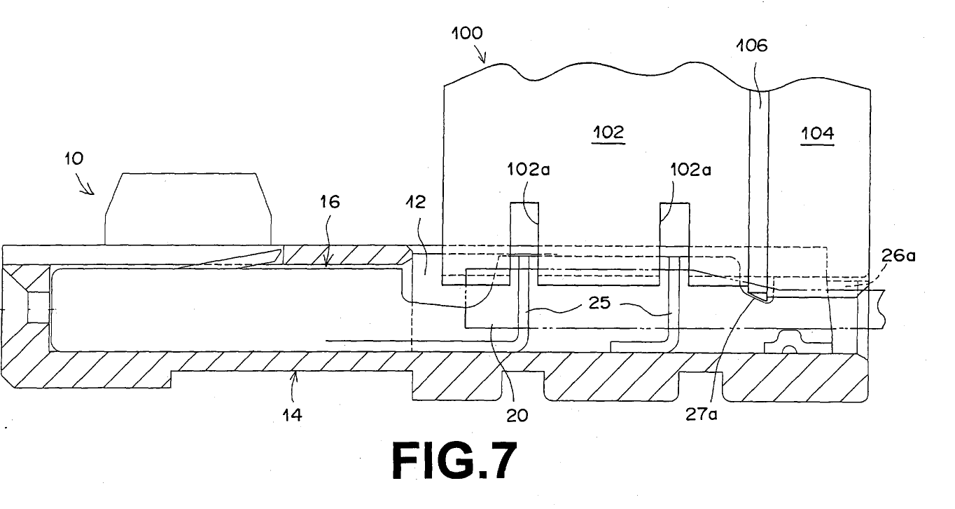

FIG. 7 illustrates the positional relationship between the press die assembly 100 and the contacts 16 when insulation displacement and crimping are complete. For clarity, and in a similar manner to FIG. 2, only the main parts of the contact 16 are shown in FIG. 7. The wires 20 have been insulation displacement connected to the insulation displacement plates 25 by the stuffers 102. In addition, the barrels 26a have been crimped around the wires 20 by the crimpers 104. The insulation displacement plates 25 have entered the recesses 102a, and the distal end portion (bottom portion) of the guide members 106 are positioned at the recesses 27a of the contacts 16.

By providing the guide members 106 as separate bodies from the crimpers 104, the crimpers 104 may be made thicker, and hence structurally stronger. This in turn facilitates two barrels 26a to be crimped simultaneously. This structure provides sufficient strength in the crimpers 104, while enabling stable crimping of the crimping pieces (barrels) 26a. If the crimpers 104 and the housing 14 are slightly positionally misaligned in the horizontal direction, interference between the crimpers 104 and the partition walls 18 is prevented by the partition walls 18 being guided, that is, spread apart, by the guide surfaces 106a and the lateral edges 114 of the guide members 106. In addition, because the guide members 106 guide the partition walls 18, the width of the crimpers 104, that is, the width in the direction perpendicular to the axial direction of the contacts 16, can be maximized between the side walls 18. In other words, the distance between the lateral edges 114 of the guide members 106 may be substantially equal to the distance between the walls. Accordingly, even if the positions of the crimpers 104 and the barrels 26a are shifted in the horizontal direction due to dimensional tolerances and the like, faulty crimping wherein one of the barrels 26a remains uncrimped can be avoided.

While the invention has been described in terms of various specific embodiments, those skilled in the art will recognize that the invention can be practiced with modification within the spirit and scope of the claims.

What is claimed is:

1. A press die assembly securing a wire to a connector having a housing holding an electrical contact that includes a crimping barrel, said press die assembly comprising:
a stuffer for pressing a wire against an insulation displacement portion of the electrical contact;
a crimper for joining a crimping barrel of the electrical contact to the wire; and
a guide member positioned between said crimper and said stuffer, said guide member being configured to properly align the housing and said stuffer and said crimper.

2. A press die assembly in accordance with claim 1, said crimper constructed of a single member having a thickness that encompasses both ends of a pair of crimping barrels on the contact.

3. A press die assembly in accordance with claim 1, said crimper comprising an arcuate surface on an end thereof, said arcuate surface having a radius of curvature greater than a radius of curvature of an outer insulative cover of the wire.

4. A press die assembly in accordance with claim 1, said guide member comprising an arcuate surface on an end thereof, said arcuate surface of said guide member substantially conforming to an outer surface of an insulative cover of the wire.

5. A press die assembly in accordance with claim 1, said crimper comprising an arcuate surface having a first radius of curvature, said guide member comprising an arcuate surface having a second radius of curvature, said first radius of curvature greater than said second radius of curvature.

6. A press die assembly in accordance with claim 1, said crimper including a distal end, said guide member including a distal end, said distal end of said guide member extending beyond said distal end of said crimper, said distal end of said guide member comprising a concave surface.

7. An insulation displacement connection apparatus for use with a connector including an insulated housing having partition walls that define a plurality of contact housing spaces for housing a plurality of electrical contacts, each electrical contact including an insulation displacement portion and a pair of crimping barrels, said apparatus comprising:
a press die assembly comprising a plurality of press blade dies, each of said press blade dies corresponding to one of the contact housing spaces of the connector, each of said press blade dies comprising:
a stuffer adapted to press a wire onto the insulation displacement portion of an electrical contact;
a guide member adapted to prevent interference between said stuffer and the partition walls of one of the contact housing spaces; and
a crimper having a thickness that encompasses both ends of the crimping barrels of the electrical contact.

8. An insulation displacement connection apparatus in accordance with claim 7, said crimper comprising an arcuate surface on an a distal end thereof, said arcuate surface crimping both barrels of the electrical contact as the press die assembly is pressed into the connector.

9. An insulation displacement connection apparatus in accordance with claim 7, said guide member comprising a concave surface on an end thereof that receives an outer insulative cover of the wire, said guide member leading said crimper into one of the contact housing spaces.

10. An insulation displacement apparatus in accordance with claim 7, said crimper comprising an arcuate surface having a first radius of curvature, said guide member comprising an arcuate surface having a second radius of curvature, said first radius of curvature greater than said second radius of curvature.

11. An insulation displacement apparatus in accordance with claim 7 wherein said guide member and said crimper have a substantially equal width.

12. A press die assembly comprising at least one press blade die, said at least one press blade die being arranged to descend upon a wire and contact to join the wire and contact, said press blade die comprising:
a stuffer adapted to press a wire onto an insulation displacement portion of a contact;
a guide member extending from said stuffer and being configured to engage a connector housing to align said stuffer and the connector housing; and
a crimper extending from said guide member opposite said stuffer and constructed of a single member having a thickness that is formed to encompasses both ends of a pair of crimping barrels, said crimper simultaneously crimping covering crimping barrels of any electrical contact to the wire as said press die assembly descends upon the connector housing, said guide member entering a contact housing space prior to said crimper.

13. A press die apparatus in accordance with claim 12, said crimper comprising an arcuate surface on an a distal end thereof, said arcuate surface crimping both barrels of the electrical contact as the press die assembly is pressed into the connector.

14. A press die apparatus in accordance with claim 12, said guide member comprising a concave surface on an end thereof that receives an outer insulative cover of the wire, said guide member leading said crimper into one of the contact housing spaces.

15. A press die apparatus in accordance with claim 12, said crimper comprising an arcuate surface having a first radius of curvature, said guide member comprising an arcuate surface having a second radius of curvature, said first radius of curvature greater than said second radius of curvature.

16. A press die apparatus in accordance with claim 12 wherein said guide member and said crimper have a substantially equal width.
